(19) United States
(12) Patent Application Publication
(10) Pub. No.: US 2006/0112575 A1
(43) Pub. Date: Jun. 1, 2006

(54) Sunniness Indicator

(76) Inventor: Thomas Welling Moran, Saratoga, CA (US)

Correspondence Address: Thomas W. Moran, 14701 Farwell Avenue, Saratoga, CA, 95070, US

(21) Appl. No.: 10/904,789

(22) Filed: Nov. 29, 2004

(51) Int. Cl. G01C 17/34

(52) U.S. Cl. 33/268

(57) ABSTRACT

A simple device for showing the sun/shade exposure of a place at any given time which includes a convex mirror reflecting the sky and a transparent flat screen inscribed with the path of the sun, with the screen balanced horizontally on the mirror so that when one looks down through the screen the paths of the sun at various times of the year are superimposed on the image of the sky and any shadow-causing obstructions. Horizontality of the flat screen is accomplished by its balancing on the convex mirror. North orientation of the flat screen can be found, if the sun is visible, by rotating the screen till the sun's image matches its path position for that time, or by using a compass if the sun is not visible.

### BACKGROUND OF THE INVENTION

Plants have different sunlight requirements. Even in a sunny climate, they may be shaded by trees or structures. This is as true for golf course greens or large formal gardens as for a simple flower outside the kitchen window. To install solar energy collectors or sundials, or to set the location of a building's windows and awnings, one also needs to know where and when the sun will shine. There is thus a need for a simple instrument to quickly and easily show the amount of sun to be expected in a particular location, at different times of day and days of the year. This invention gives a simple and portable means to show what the sun or shade condition will be on a sunny day at a particular place and time.

There have been a variety of solutions, all of greater complexity:

U.S. Pat. No. 2,478,315, Pollman, August, 1949, is a complex analog calculator designed for high accuracy use at an architect's desk.

U.S. Pat. No. 2,884,697, Sylvester, May, 1959, involves building a scale model and illuminating it to simulate sunlight—a complicated solution.

U.S. Pat. No. 4,177,566, Haines, Dec. 11, 1979 uses a “transparent reflective dome” over a flat marked grid. The grid sheet is on a plate on a tripod with a means to make it level. This complexity and the necessary adjustments impede a quick survey.

U.S. Pat. No. 4,288,922, Lewis, Sep. 15, 1981 uses a horizontal viewer with a wide-angle lens, mounted horizontally on a table and tripod arrangement, through which the user looks at and through a vertically mounted transparent sheet with sun-path markings. Such a device is inconvenient to carry around and set up.

U.S. Pat. No. 4,635,371, Dalrymple, Jan. 13, 1987 uses a viewer similar to that of U.S. Pat. No. 4,28,922 but puts the path markings directly on the lens. The patent's “Background” points out that “In rural settings, as well as some urban settings, it is very inconvenient to transport a table and other paraphernalia around a site”. Though the invention is hand held, it would seem difficult to look through a tubular viewer while also looking at a level indicator. Such a viewer also has the disadvantage of requiring the user to look at the sun, an uncomfortable, if not downright unhealthy, practice.

U.S. Pat. No. 4,678,330, Gutschick, et al., Jul. 7, 1987 uses light sensors mounted at various locations and a computer to integrate the data so obtained. This is neither quick nor simple.

U.S. Pat. No. 6,338,027, Fulton, Jan. 8, 2002 constructs a computer virtual model of the environment. Another complex solution.

### SUMMARY OF THE INVENTION

The user of this invention goes to the place of interest and places or holds there a convex mirror. He looks straight down on the mirror and sees a reflection of the whole sky. Balanced on the mirror (and thus horizontal) is a rigid transparent planar sheet on which are inscribed one or more arcs indicating the path of the sun during the course of the day at that latitude. The user thus sees the path superimposed on the image of the sky and surroundings. If the path, say, crosses empty sky from noon to 1 pm, and then crosses the image of sparse tree leaves from 1 to 2 pm, and then crosses the image of a nearby building for the rest of the day, then there will be unobstructed sun from noon to 1 pm, “dappled shade” from 1 to 2 pm, and shade thereafter. The rigid flat sheet is necessarily horizontal, or close enough to it, by virtue of the fact it will simply slide off the convex mirror otherwise. The inscribed arc(s) must have the correct North-South orientation, which is accomplished either with a compass or by simply using the device when the sun is shining and rotating the sheet until the sun's image appears where the arc(s) indicate it should be at that particular time. An embodiment of the invention thus consists of a convex mirror, which could in fact be a simple decorative reflective chrome sphere, and a matching rigid, flat, transparent sheet suitably inscribed. Since the device is hand-held, it can easily be moved to another position horizontally, or vertically, to see the sunlight situation there. In particular, it can be placed on the ground, where a low-growing plant might be, and viewed conveniently from above. This contrasts with the horizontal tube devices which would require their user to lie flat on the ground.

This device, like that of U.S. Pat. No. 4,635,371, is simple, hand held, and easily carried through rough terrain. Unlike that device, however, it does not require a separate level indicator, the user does not have to do contortions to place his eye adjacent to an eyepiece, and the sun's image, if present, is reflected in a good size convex mirror, making it less intense than a direct view through a lens.

### DESCRIPTION OF THE DRAWINGS

FIG. 1 is an isometric drawing of an embodiment of the device showing (1) the convex mirror or sphere (shown here as a sphere for clarity), on which rests a rigid transparent sheet (2), balanced at its center (3), on which are inscribed arcuate line(s) (4) showing the path of the sun at one or more times of the year. These path lines are labeled (5) with a date and, in the preferred embodiment shown here, also with time of day markings. The path of the sun is dependent on latitude, and the hour markings, if present, are dependent on longitude, so the transparent sheet (2) has a label (6) showing the latitude, and preferably also the longitude, for which the particular sheet is intended. In the preferred embodiment shown here, the azimuthal indication of true North is indicated both by label (6) and also by an indication near the center (3). The center (3) is surrounded by a circular sighting mark where, for greatest accuracy, the user should see his eye reflection. There may also be other labels, advertisements, instructions, etc, as exemplified by (7) on FIG. 1.

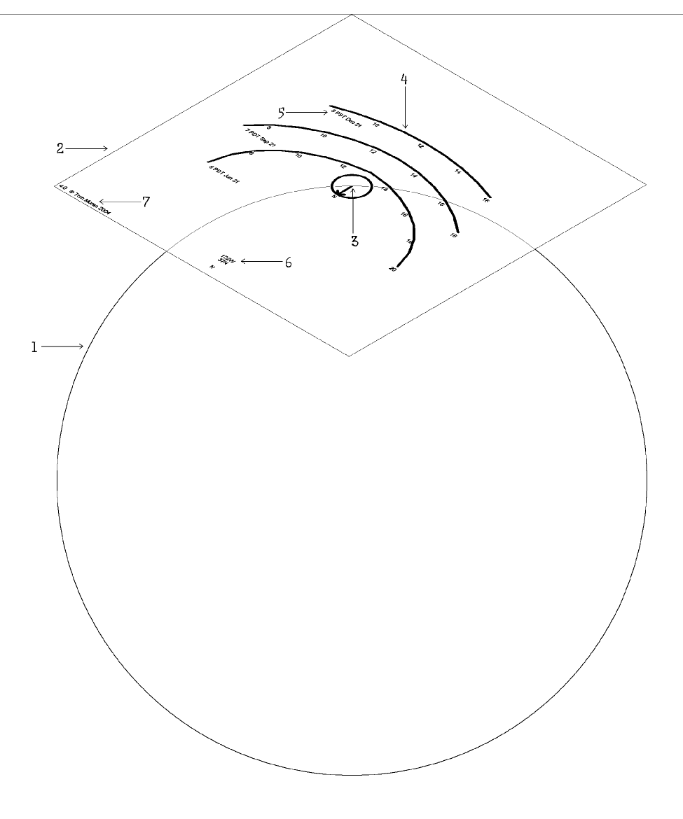

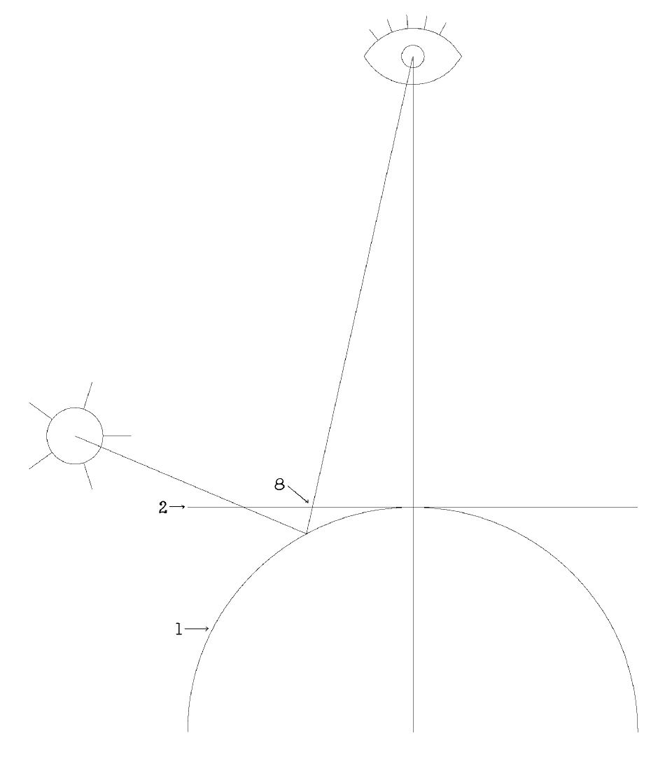

Of these various markings, the only one truly essential to operation is an indication of sun positions, here an arcurate line (4), for (approximately) the particular date. The center is self-locating since it is the balancing point of the sheet on the mirror. The sheet is oriented to true North by noting the actual position of the sun and rotating the sheet to bring that into congruence with the path line. The other markings are labels for the convenience of the user and could be modified as desired. If it's not convenient to use the actual sun position for azimuthal orientation (on a cloudy day or at night, for instance), a compass reading, corrected for magnetic declination, can be used.

The path of the inscribed arcurate line(s) (4) is determined by the well known astronomical formulae for the azimuth and elevation angles of the sun, combined with the simple geometry of an eye looking down on a sphere of a given radius, the line being drawn at the locus of intersections of the reflected ray of the sun through the transparent sheet. If the eye is directly above the center of the mirror said locus will depend on the height of the eye. The dependence is small for reasonable eye heights and sun elevations, so a single compromise value for eye height could be used with only minor inaccuracy.

FIG. 2 diagrams the geometry of a ray of the sun reflecting off the convex mirror (1) and passing through the transparent sheet (2) on its way to the observer's eye. The sun path marking would thus be at position (8).

In the preferred embodiment, the sheet (2) is about 7 inches square and the convex mirror (1) has a radius of curvature of about 4 inches. Those sizes are convenient to hold in the hand and look straight down on from above the center of the sheet. Too much larger and it becomes more difficult to handle; too much smaller and the image in the convex mirror becomes small and hard to see. For garden use, a mirror surfaced 8 inch “gazing globe” could be such a convenient convex mirror, and it would remain decorative when not in use for this invention. “Eye height” would then be roughly 16 inches if the mirror is held waist high to 40 inches in the extreme case of the sphere on the ground and the user standing looking down.

What is claimed is:

1. A device for forming a visual representation of the quantity of solar exposure of a specific place, comprising:
a means reflecting an image of the surroundings;
an inscribed rigid transparent planar sheet means for forming a composite visual image of said inscription with said reflected image, the inscription including indications of the path of the sun's travel during the course of a day; and
a means for leveling said sheet with respect to the horizontal.

2. The device of claim 1 wherein said reflecting means comprises a convex mirrored surface.

3. The device of claim 2 wherein said rigid transparent planar sheet is leveled by balancing it on said mirrored surface.

4. The device of claim 3 wherein said inscription contains one or more arcurate lines indicating the path of the sun's daily travel at a particular location and time of year.

5. The device of claim 4 with the addition of a sighting mark to assist the user in more accurate eye placement.

6. The device of claim 4 with the addition of an azimuthal indication allowing use without depending on a reflection of the sun for azimuthal orientation.

7. The device of claim 3 with additional inscribed labels, instructions, or advertising.
